(19) United States
(12) Patent Application Publication
(10) Pub. No.: US 2016/0046077 A1
(43) Pub. Date: Feb. 18, 2016

(54) ADDITIVE MANUFACTURING SYSTEM AND METHOD

(71) Applicant: Central University of Technology, Free State, Bloemfontein (ZA)

(72) Inventor: lhar YADROITSAU, Bloemfontein (ZA)

(73) Assignee: Central University of Technology, Free State, Bloemfontein (ZA)

(21) Appl. No.: 14/828,153

(22) Filed: Aug. 17, 2015

(30) Foreign Application Priority Data
Aug. 15, 2014 (ZA) 2014/06018

(51) Int. Cl. B29C 67/00; B23K 26/03; B23K 26/342

(52) U.S. Cl. CPC B29C 67/0088; B29C 67/0077; B23K 26/342; B23K 26/032; B33Y 30/00

(57) ABSTRACT

The invention relates to an additive manufacturing system 10 for manufacturing a product 300 layer-by-layer. The system 10 includes a production arrangement 12 which is configured to manufacture a product 300 layer-by-layer upon receiving instructions from a control arrangement 32. The control arrangement 32 is operatively connected to the production arrangement 12 and is configured to control the operation of the production arrangement 12 by providing control instructions for each layer of a product 300 to be manufactured to the production arrangement 12. The system 10 includes an optical monitoring arrangement 14 which is configured to capture an image of a layer manufactured by the production arrangement and/or a layer of source material laid/placed over a previously manufactured layer of the product 300. The optical monitoring arrangement 14 is also configured to send the captured image to the control arrangement for processing. The control arrangement 32 is configured to analyse the received captured image and, if required, to adjust control instructions for the manufacturing of the next layer.

### BACKGROUND OF THE INVENTION

THIS invention relates to an additive manufacturing system/machine for manufacturing a product layer-by-layer, as well as to a method of manufacturing a product layer-by-layer.

FIG. 2 shows an example of how developers of selective laser melting equipment have tried to introduce diagnostic systems for the equipment. These systems typically capture light emissions during manufacturing by making use of photodiode-based sensors which are mounted either on the scanner (see reference numeral (a)) or inside the process chamber/enclosure 202 (see reference numeral (b)). These systems necessitate the collection of a large amount of data, which is very difficult and time-consuming to analyse. In addition, since there is a constant, intensive emission of material during the laser processing (see specifically FIG. 3), the successful interpretation of the signal from the sensor and its dynamics is not a trivial task.

Modern selective laser melting machines apply high power laser systems (400-1000 W) and very fast scan speeds (typically 1-2 m/s). Hence, a typical laser spot size of 100 μm requires a processing time of less than 50 us to analyse the selective laser melting process at the laser's most recent position in order to respond to the processing outcome.

### SUMMARY OF THE INVENTION

In accordance with one aspect of the invention there is provided an additive manufacturing system/machine for manufacturing a product layer-by-layer, wherein the system/machine includes:
a production arrangement which is configured to manufacture a product layer-by-layer from source material, upon receiving instructions from a control arrangement, when in use;
a control arrangement, including a processor, which is operatively connected to the production arrangement and which is configured to control the operation of the production arrangement by providing control instructions for each layer of a product to be manufactured to the production arrangement, which can then be used by the production arrangement in order to manufacture the product layer-by-layer;
an optical monitoring arrangement which is configured to capture an image of
   a layer manufactured by the production arrangement, during the layer-by-layer manufacturing of a product, and/or
   a layer of source material laid/placed over a previously manufactured layer of the product,
and wherein the optical monitoring arrangement is also configured to send the captured image to the control arrangement for processing,

wherein the control arrangement is configured to analyse the received captured image and, if required, to adjust control instructions for the manufacturing of the next layer and send the adjusted control instructions to the production arrangement.

The additive manufacturing system/machine may be a laser melting system/machine. The laser melting system/machine may be a selective laser melting system/machine.

The control arrangement may include file preparation software which is configured to generate/assign control instructions/parameters for each layer of a product to be manufactured, wherein the control instructions/parameters are derived from/based on a file which is in stl (StereoLithography) format (hereinafter referred to as the “STL file”) and which includes information on a three-dimensional software representation of the product to be manufactured. The control arrangement may therefore be configured to generate/assign control instructions as described above and to adjust/change the control instructions for each layer, if required, after analysing the captured image.

The STL file may typically be derived from a three-dimensional software model of the product to be manufactured. More specifically, the three-dimensional model may be a computer aided design (CAD) model.

The production arrangement may include:
an energy source;
a production surface/platform on which a product can be manufactured layer-by-layer during use; and
a supply arrangement which is configured to supply source material for each layer to the production surface/platform, during operation of the machine/system, which can be used to manufacture each layer of the product.

The energy source may be a laser.

The production arrangement may include a scanner system which is configured to direct energy/power emitted from the energy source selectively towards a layer of source powder provided on top of, or laid over, the production surface/platform, during manufacturing, in order to manufacture a particular layer of the product. The scanner system may include a scanner head.

The source material may typically be in powder form (hereinafter referred to as the “source powder”). The supply arrangement may therefore typically be configured to supply the source powder on a layer-by-layer basis on top of/over the production surface/platform, in order to allow the production arrangement to manufacture the product layer-by-layer. The supply arrangement may include a coating mechanism which is configured to distribute a layer of source powder over a previously manufactured layer of the product provided on the production surface/platform in order to allow the following layer of the product to be manufactured. The coating mechanism may include a roller for distributing the source powder over the previously manufactured layer of the product.

The supply arrangement may include a supply chamber which is configured to store the source material at least temporarily. The coating mechanism may therefore be configured to distribute the layer of source powder by obtaining source powder from the supply chamber.

The optical monitoring arrangement may include a camera for capturing an image of a manufactured layer and/or a layer of source material, as described above. The optical monitoring arrangement may include a light which is used as a lighting source for the camera, i.e. for exposure purposes, in order to allow the camera to capture an image as mentioned above, with sufficient light exposure in order to allow the control arrangement to analyse the captured image.

The control arrangement may be configured, by way of software, to evaluate/identify surface irregularities of a layer manufactured by the machine/system, by analysing a captured image of the manufactured layer received from the optical monitoring arrangement. More specifically, the control arrangement may be configured, by way of software, to identify a region(s)/location(s) where surface irregularities are present on the manufactured layer. The control arrangement may accordingly be configured to adjust control instructions for the next layer to be manufactured, if needed, based on at least the identified surface irregularities in the captured image.

The control arrangement may be configured to adjust the control instructions, if needed, for the next layer to be manufactured in respect of the particular region(s)/location(s) in/at which surface irregularities have been identified. In other words, wherein no irregularities have been detected, the control instructions for those specific region(s)/location(s) may remain substantially unchanged, however, where the surface irregularities have been identified, the control instructions for those specific region(s)/location(s) can be adjusted, if required (e.g. if the irregularities are significant enough to justify a change in control instructions). The control arrangement may be configured to create/draw up a topographic map of the manufactured layer which image was captured, based on the evaluation/identification of the surface irregularities.

Stated slightly differently, the control arrangement may be configured, by way of software, to evaluate a surface topology of a layer manufactured by the machine/system, by analysing a captured image of the said layer received from the optical monitoring arrangement. The control arrangement may accordingly be configured to adjust control instructions for the next layer to be manufactured, if needed, based on the analysed surfaced topology. The control arrangement may be configured to identify region(s)/location(s) in/at which surface irregularities are present by analysing a captured image and, if needed, to adjust the control instructions in respect of those particular region(s)/location(s) for the next layer. In other words, where no irregularities have been detected, the control instructions for those specific region(s)/location(s) for the next layer may remain substantially unchanged, however, where the surface irregularities have been identified, the control instructions for those specific region(s)/location(s) can be adjusted, if required (e.g. if the irregularities are significant enough to justify a change in control instructions). The control arrangement may be configured to create/draw up a topographic map of the manufactured layer which image was captured, based on an evaluation of the surface topology.

The captured image is effectively a cross-sectional view of the product that is being manufactured (layer-by-layer).

The control arrangement may be configured, by way of software, to superimpose the captured image, or an adaptation/derivative of the captured image, on/over a cross-section of the three-dimensional software model of the product, wherein the cross-section corresponds with the layer which image was captured. The control arrangement may then be configured, by way of software, to adjust control instructions for the next layer to be manufactured, if needed, based on an analysis of the superimposition of the captured image, or the adaptation/derivative of the captured image, on/over the said cross-section.

The optical monitoring arrangement may be configured to capture:
a first image of a first layer manufactured by the production arrangement, during the layer-by-layer manufacturing of a particular product, and
a second image of a layer of source material laid/placed over the first layer, wherein the layer of source material is to be used for manufacturing a next layer of the product.

The second image is therefore captured after the layer of source material for the next layer has been laid/placed over the first layer, but before the production arrangement actually manufactures the next layer.

The control arrangement may be configured, by way of software, to analyse both the first and second images and, if required, based on the analysis, to adjust control instructions for the second layer and send the adjusted control instructions to the production arrangement. The first and second images may each be analysed by the control arrangement in a similar manner as described above (i.e. in order to evaluate/identify surface irregularities or to evaluate a surface topology of the layer).

More specifically, the control arrangement may be configured, by way of software, to compare the first image with the second image and, if required, based on the comparison, to adjust control instructions for the next layer and send the adjusted control instructions to the production arrangement.

Even more specifically, the control arrangement may be configured, by way of software, to superimpose both of the captured images, or adaptations/derivatives of the captured images, on/over a cross-section of the three-dimensional software model of the product, wherein the cross-section corresponds with the layer which image was captured. The control arrangement may then be configured, by way of software, to adjust control instructions for the next layer to be manufactured, if needed, based on an analysis of the superimposition of the two captured images, or the adaptations/derivatives of the captured images, on/over the said cross-section.

In accordance with another aspect of the invention there is provided a method of manufacturing a product layer-by-layer by utilising an additive manufacturing machine/system, the method including:
manufacturing a first layer of the product by using the additive manufacturing system;
capturing a first image of the first layer;
analysing, by using processor, at least the captured first image and determining, by using a processor, whether or not control instructions for the system for the manufacturing of a next layer need to be adjusted/altered, and
if needed, adjusting control instructions for the manufacturing of the next layer by using a processor.

The steps of analying the first image and adjusting the control instructions may be implemented by using appropriate software.

This step of analysing the captured first image may include identifying surface irregularities in the manufactured first layer from at least the captured image.

The step of analysing the captured first image may include superimposing at least the captured first image, or an adaptation/derivative of the captured first image, on/over a cross-section of a three-dimensional software model of the product, wherein the cross-section corresponds with the first layer. The three-dimensional model may be a computer aided design (CAD) model. The step of analysing the captured first image may therefore include analysing the superimposition of the captured first image, or an adaptation/derivative of the captured first image, on/over the three-dimensional software model of the product.

The method may further include, after capturing the first image, delivering a layer of source material over the first manufactured layer, for the next layer of the product to be manufactured.

The method may include, after delivering the layer of source material for the next layer, capturing a second image of the layer of source material. The step of analysing may include analysing, by using a processor, both the first and second images, and, if needed, adjusting control instructions for the manufacturing of the second layer, based on the analysis. More specifically, the step of analysing the captured images may include superimposing the captured first and second images, or adaptations/derivatives thereof, on/over a cross-section of a three-dimensional software model of the product, wherein the cross-section corresponds with the first layer.

The three-dimensional model may be a computer aided design (CAD) model. The step of analysing the captured images may include analysing the superimposition of the captured images, or adaptations/derivatives thereof, and the three-dimensional software model of the product.

The step of analysing, by using a processor, the captured image(s) may include evaluating/identifying surface irregularities in the first layer by utilising the captured image(s). More specifically, the step of analysing the captured image(s) may include identifying, by using software, region(s)/location(s) where surface irregularities are present on the first layer, by utilising the captured image(s).

The step of determining whether or not control instructions need to be adjusted/altered may include having regard to the identified surface irregularities in order to determine whether or not control instructions need to be adjusted/altered. More specifically, the step of determining whether or not control instructions need to be adjusted/altered may include adjusting/altering control instructions for a specific region(s)/location(s) for the next layer to be manufactured in respect of the particular region(s)/location(s) in/at which surface irregularities have been identified. In other words, where no irregularities have been detected, the control instructions for those specific region(s)/location(s) may remain substantially unchanged, however, where surface irregularities have been identified, the control instructions for those specific region(s)/location(s) may be adjusted, if required (e.g. if the irregularities are significant enough to justify a change in control instructions).

The step of analysing the image(s) may include creating/drawing up, by utilising software, a topographic map of the manufactured first layer which image was captured, by evaluating/identifying the surface irregularities. In accordance with a further aspect of the invention there is provided a non-transitory computer-readable storage medium having computer-executable instructions adapted to cause an additive manufacturing machine/system, which is configured to manufacture a product layer-by-layer, to perform the method as described above.

The patent or application file contains at least one drawing executed in color. Copies of this patent or patent application publication with color drawing(s) will be provided by the Office upon request and payment of the necessary fee.

### BRIEF DESCRIPTION OF THE DRAWINGS

The invention will now be described, by way of example, with reference to the accompanying diagrammatic drawings. In the drawings:

FIG. 1 shows a schematic step-by-step illustration of a typical process which is followed when manufacturing an article from a three-dimensional software model, by using an additive manufacturing system/machine;

FIG. 2 shows a schematic side view of a prior art selective laser melting machine;

FIG. 3 shows an illustration of a layer of a product being manufactured;

FIG. 4a shows a schematic illustration of part of an additive manufacturing system in accordance with the invention;

FIG. 4b shows a simplified layout of the system of FIG. 4a;

FIG. 5a shows an image captured by a camera of an optical monitoring arrangement of the system of FIG. 4a, of a manufactured layer of a product;

FIG. 5b shows a slight adaptation of the image of FIG. 5a;

FIG. 5c shows an illustration of the adapted image of FIG. 5b superimposed on a corresponding cross-section of a three-dimensional software representation of the product;

FIG. 5d shows an image captured by the camera after a layer of source powder has been laid over the manufactured layer illustrated in FIG. 5a;

FIG. 5e shows an adaptation of the image of FIG. 5d, in which no regions with irregularities have been identified;

FIG. 5f shows an illustration of an adapted image of FIG. 5e superimposed on a corresponding cross-section of a three-dimensional software representation of the product;

FIG. 6a shows an image captured by the camera of the system of FIG. 4a of a manufactured layer of a product;

FIG. 6b shows an adaptation of the image of FIG. 6a, where a region in which surface irregularities are identified has been contoured/identified;

FIG. 6c shows an illustration of the contoured region of FIG. 6b superimposed on a corresponding cross-section of a three-dimensional software representation of the product;

FIG. 6d shows an image captured by the camera after a layer of source powder has been laid over the manufactured layer illustrated in FIG. 6a;

FIG. 6e shows an adaptation of the image of FIG. 6d, where regions in which surface irregularities were identified have been contoured/identified;

FIG. 6f shows an illustration of wherein the contoured regions shown in FIGS. 6c and 6e have been superimposed on a corresponding cross-section of a three-dimensional software representation of the product;

FIG. 7 shows the superimposition of FIG. 6f in greater detail;

FIG. 8 shows a three-dimensional representation of the product in which possible surface irregularities have been identified;

FIG. 9 shows a simplified flow diagram of the interaction between different parts of the system of FIG. 4a.

### DESCRIPTION OF PREFERRED EMBODIMENTS

The invention relates to an additive manufacturing machine/system for manufacturing a product layer-by-layer. More specifically, the additive manufacturing system is a selective laser melting system which is configured to monitor the layer-by-layer manufacturing of the product and to adjust control instructions/parameters during the manufacturing in order to help correct possible defects during the manufacturing.

More specifically, the system is configured to analyse each layer that is manufactured and, if required, to adjust control instructions for the following layer based on the analysis. For instance, if certain surface irregularities are identified in certain regions of a manufactured layer, then control instructions for those specific regions for the following layer can be adjusted in order to try and compensate for, or correct, the irregularities. The system is also configured to flag/identify those specific regions/places where potential defects (e.g. surface irregularities) may be located and which may be presented to the manufacturer for further analysis.

Each manufactured layer is analysed by capturing an image thereof and then again capturing another image after a layer of source powder (for manufacturing the next layer) is distributed over the manufactured layer. These images are then compared with/superimposed on a cross-section of a three-dimensional software model of the product which corresponds to the particular layer which was manufactured. Based on this comparison/superimposition, possible defects/irregularities in the manufactured layer can be detected.

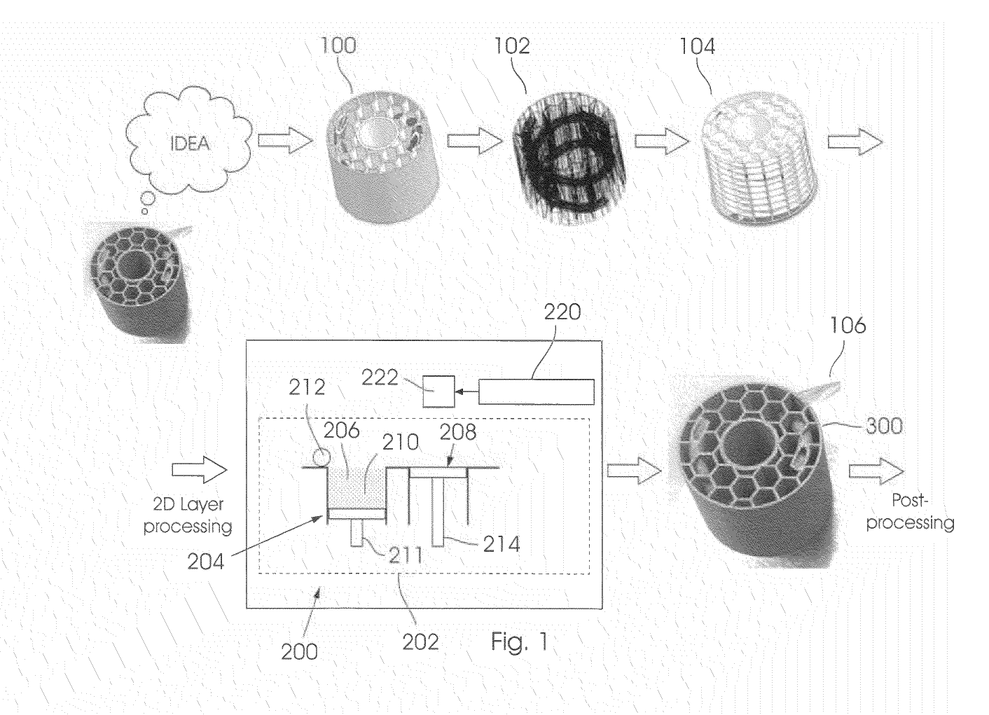

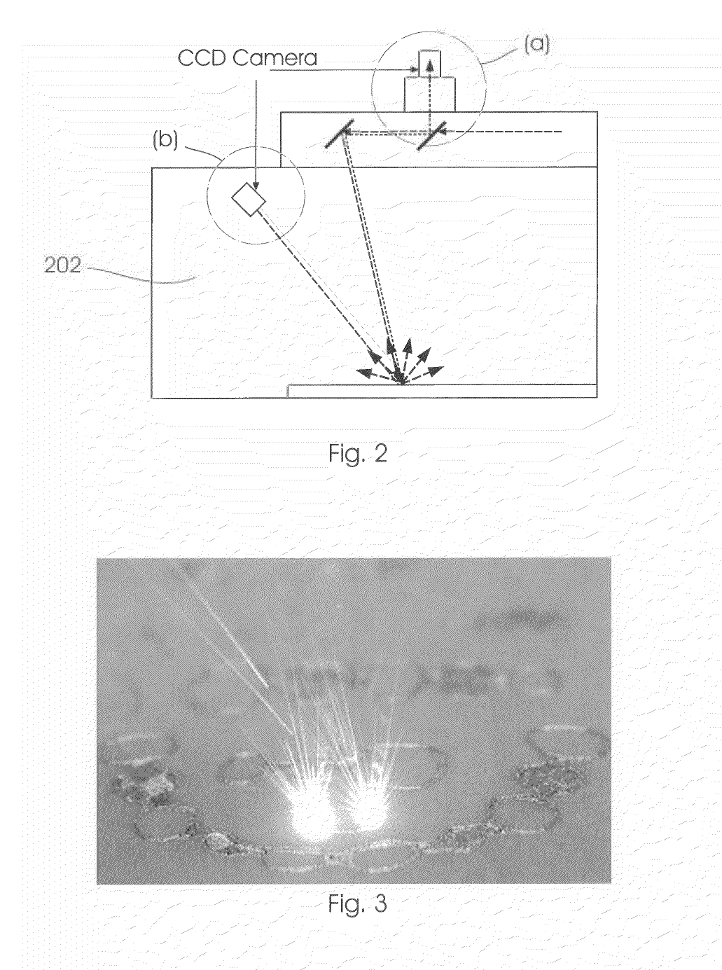

Reference is now made to FIG. 1 which illustrates a step-by-step process which is followed when manufacturing an article/product 300 from a three-dimensional software model. The first step is typically to design a three-dimensional computer aided design (CAD) model of the product 300 to be manufactured by using an appropriate software package (see reference numeral 100). Once designed, the model is converted to STL (StereoLithograph) format (see reference numeral 102) and sliced/divided into several cross-sectional layers (see reference numeral 104). Control instructions/parameters are then generated for each of the layers, which are then utilised/interpreted by a manufacturing machine/printer (hereinafter referred to as “the production arrangement 200”) in order to print/manufacture the product layer-by-layer. Once all the layers have been manufactured/printed (see reference numeral 106), the manufactured product 300 can be taken for further processing.

The production arrangement 200 typically includes a manufacturing workspace/enclosure 202 within which the product 300 is manufactured layer-by-layer, a feeding/supply arrangement 204 for supplying source material 206 for manufacturing each layer, a production platform/surface 208 on which the product 300 is manufactured, a power source in the form of a laser 220 and a scanner 222 which is configured to direct power/energy emitted from the laser 220 towards a layer of source material provided on top of the platform 208 (or a previously manufactured layer provided on the platform 208) in order to fuse certain portions of the source material 206 to thereby manufacture the particular layer.

The supply arrangement 204 includes a supply chamber 210 which is configured to store the source material 206 temporarily, a piston 211 which effectively defines a bottom surface of the supply chamber 210 and which is configured to move operatively upwardly and downwardly, and a roller 212 which is configured to distribute/roll an upper portion/layer of the source material 206 located in the chamber 210 onto the platform 208 or a previously manufactured layer of the product 300 located on the platform 208. More specifically, the piston 211 is configured to move slightly upwardly each time the supply arrangement 204 needs to supply the next layer to the platform 208 for manufacturing, in order to allow the roller/application device 212 to roll/distribute an upper portion of the source material 206 onto the platform 208 or a previously manufactured layer of the product 300 being manufactured.

The platform 208 is typically defined by an upper planar surface of a piston 214 which is also movable operatively upwardly and downwardly. More specifically, the piston 214 is configured to move slightly downwardly each time a new/next layer needs to be manufactured. Therefore, as a product 300 is being manufactured, the piston 211 moves slightly upwardly each time a new/next layer needs to be manufactured, while the piston 214 moves slightly downwardly in order to allow the roller/application device 212 to distribute a layer of source material 206 onto a previously manufactured layer provided on the platform 208. The operation of these types of manufacturing systems (also sometimes referred to as three-dimensional printing) is well known and will therefore not be described in greater detail.

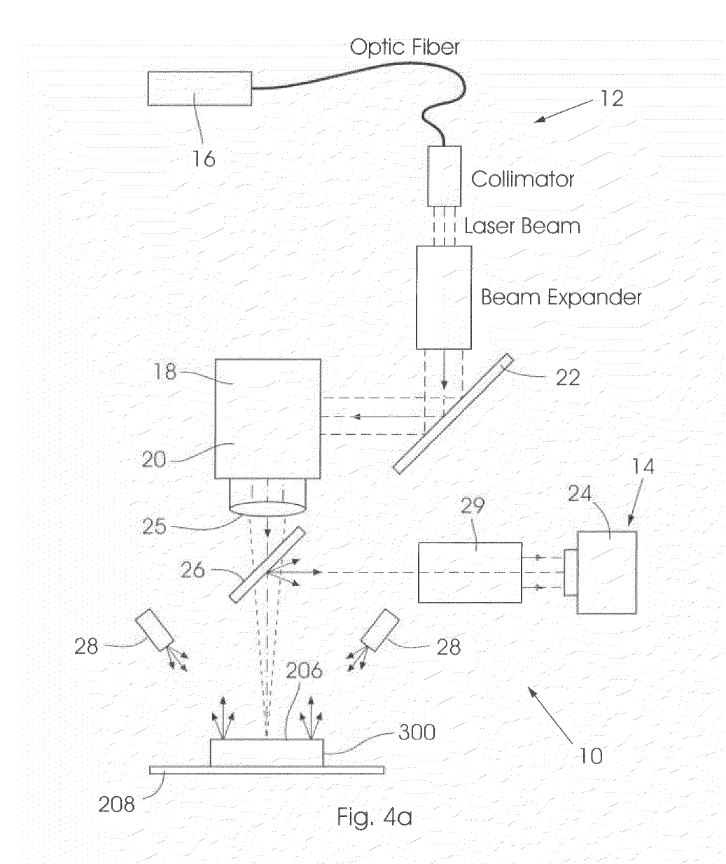

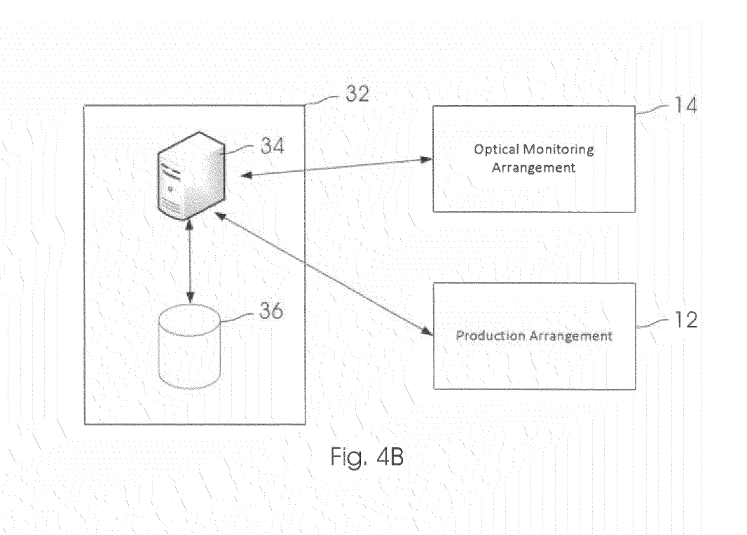

The present invention will now be described in more detail below, with reference to FIGS. 4a-9.

FIG. 4a shows a typical layout of some of the components of a selective laser melting system 10 in accordance with the invention. The system 10 includes, amongst others, a production arrangement 12 and an optical monitoring arrangement 14. The general operation of the system 10 for supplying source material 206 to a platform 208 and fusing the source material for manufacturing each layer, is very similar to the process described above (with reference to FIG. 1). The components of the production arrangement 12 is therefore very similar to the production arrangement 200 described above, and therefore will not again be described in detail. For this reason, FIG. 4a only shows some of the components of the production arrangement 12.

The production arrangement 12 includes, amongst others, a laser 16, a scanning system 18, which includes two galvanometer scanners with movable mirrors 20, and a mirror 22 which is configured to deflect power/energy emitted from the laser 16 towards the scanning system 18. The two galvanometer scanners 20 is movable in order to allow the power/energy emitted from the laser 16 to be directed to various parts of the platform 208 in order to manufacture the different portions of each layer of the product 300 to be manufactured. An F-theta lens 25 is designed to provide a flat field of laser beam at the platform 208 of the scanning system 18.

The optical monitoring arrangement 14 includes a CCD camera 24, a deflection mirror 26 which is configured to deflect images/light from each delivered layer of source material 206 laid/placed over the manufactured layer and manufactured layer of the product 300 located on the platform 208, to the camera 24. More specifically, the deflection mirror 26 is arranged between the F-theta lens 25 and the camera 24, such that the camera 24 would be able to capture an image of the platform 208 or any layer of a product 300 being manufactured.

A uniform diffused light from LED sources 28 is provided inside an enclosure of the production arrangement 12 and is used for illuminating the enclosure, more specifically the area/zone which is captured by the camera 24. The light is therefore, in essence, used as the lighting for the camera 24 exposure and is configured to provide the camera 24 with sufficient light exposure with regards to image recognition, which can be used for identifying/sensing irregularities on a surface of a manufactured layer. A camera lens 29 is used for the construction of the image in the camera 24.

Referring now also to FIG. 4b, the system 10 also includes a control arrangement 32. The control arrangement 32 typically includes a computer which incorporates a processor 34 and a database 36. The processor 34 is operatively connected to both the production arrangement 12 and the optical monitoring arrangement 14. More specifically, the processor is configured, by way of software (which is typically saved on the database 36), to send control instructions to the production arrangement 12 in order to direct the manufacturing of a product 300. The processor 34 is also configured, by way of software, to send an instruction to the camera 24 to capture an image of a layer manufactured by the production arrangement 12 and to receive the captured image from the camera 24 for further processing.

The processor 34 is configured, by way of software, to convert a three-dimensional software model into a number of layers, in a manner as described above with reference to FIG. 1. The software is then further configured to generate/calculate control instructions/parameters for each layer to be manufactured for controlling the operation of the production arrangement 12, more specifically the laser 16 and scanning system 18. These control instructions for each layer are then sent to the production arrangement 12 in order to manufacture the product 300 layer-by-layer.

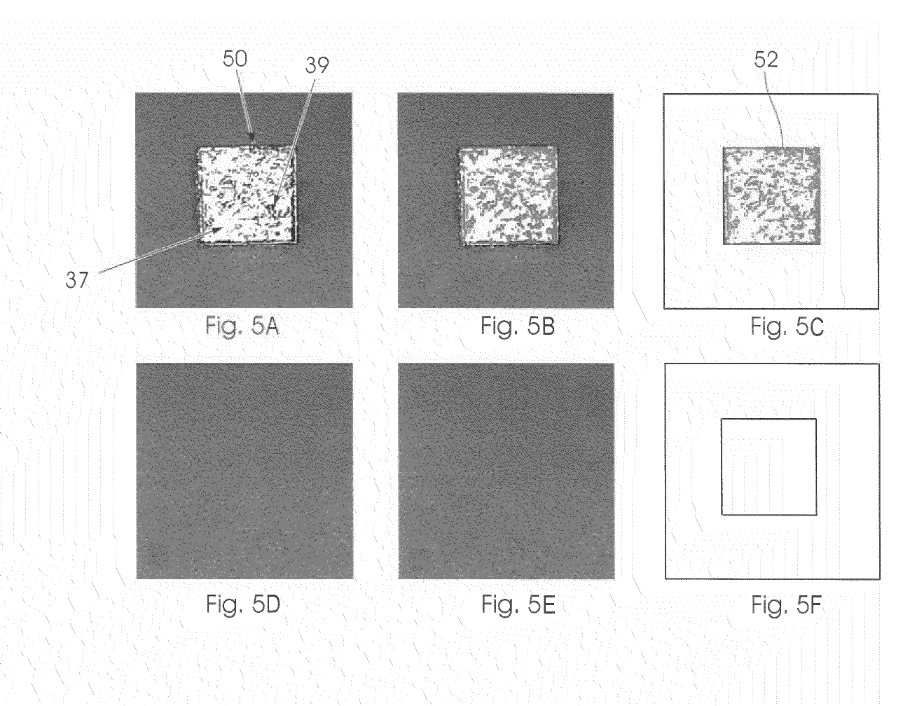

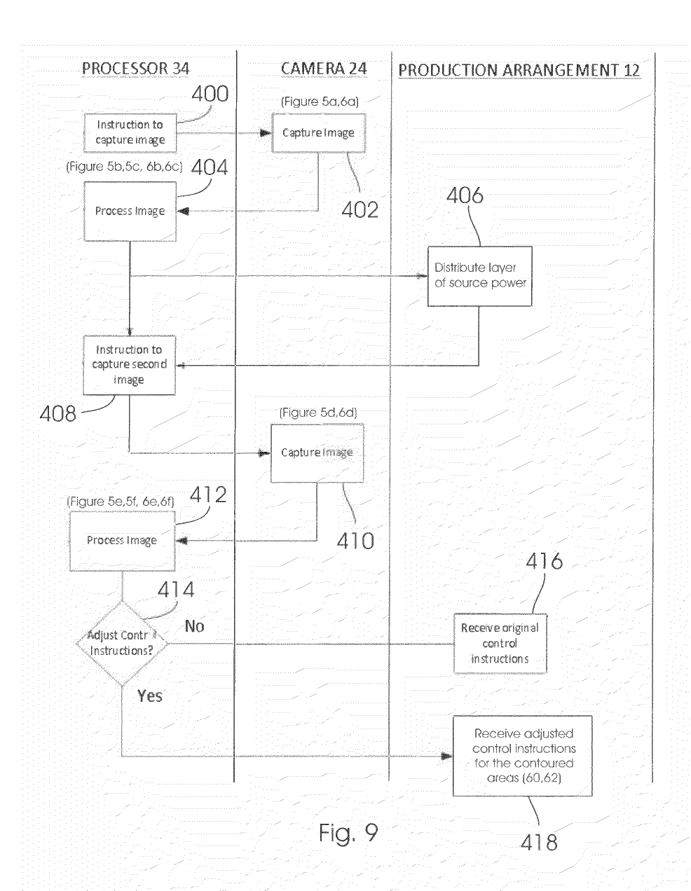

The processor 34 is further configured, by way of software, to send an instruction to the camera 24 to capture an image of a manufactured layer immediately after the manufacturing thereof by the production arrangement 12 (see also FIG. 9, block 400). The camera 24 then captures (see FIG. 9, block 402) and sends the image to the processor 34 for further processing (see FIG. 9, block 404). The image is therefore, in essence, the most recent exposed cross-section of the product 300 that is being manufactured. FIG. 5a illustrates an example of a captured image, where the generally square-shaped feature 50 represents a cross-section of a product being manufactured.

After the image has been captured by the camera 24, the processor 34 instructs the production arrangement 12 to distribute a layer of source powder 40 for the next layer to be manufactured (see FIG. 9, block 406). However, before sending control instructions for the next layer to the production arrangement 12, it again sends an instruction to the camera 24 to capture an image (see FIG. 9, block 408) of the first layer covered by the source powder 40 for the next layer to be manufactured. The camera 24 again captures an image (see FIG. 9, block 410) and sends it to the processor 34 for further processing (see FIG. 9, block 412).

This process is described in more detail below.

The processor 34 is configured, by way of software, to determine the level of greyness of the pixels which comprise the captured image. The bright areas in the captured image (more specifically bright areas within the cross-section of the manufactured layer captured by the image) (see for example reference numeral 37) typically indicate smooth surfaces of the manufactured layer, whereas dull, grey areas in the captured image (again more specifically dull, grey areas within the cross-section of the manufactured layer captured by the image) (see for example reference numeral 39) indicates a height deviation from an average height of an area of the cross-section which surrounds the dull, grey area. In this regard it should be understood that the terms “bright” and “dull, grey” refer to an ordinary greyscale.

The processor 34 is therefore, in essence, configured to assess the greyness of the individual pixels in order to determine which areas of the cross-section which image has been captured are smooth and which are irregular. As a result, the processor 34 is therefore generally configured to create/draw up a type of topographic map for a particular cross-section of the product being manufactured.

The processor 34, by utilising software, processes the image in such a manner that those areas of the manufactured surface that do not meet the required quality are identified for further corrective processing (see FIGS. 5a and 5b). An image of this area is superimposed (see FIG. 5c) on a cross-section 52 of a CAD model of the product being manufactured, wherein the cross-section corresponds to the manufactured layer of the product which image was captured by the camera 24 (e.g. in this example the particular cross-section of the CAD model of the product is generally square).

By superimposing the image on the cross-section of the CAD model, a topographic map of the layer which was manufactured is obtained for the particular cross-section. For the sake of clarity, the image is hereinafter referred to as the “first image”.

The processor 34 is configured, by way of software, to send an instruction to the production arrangement 12 to place/lay a layer of source powder 40 over the previously manufactured layer. After the layer of source powder 40 has been laid, the processor 34 instructs the camera 24 to capture an image of the source powder 40 layer (see FIG. 5d). After the processor 34 receives the image, it again analyses the image in terms of greyness, by utilising appropriate software (see FIG. 5e).

In this instance, the software allows the processor 34 to detect possible deviations in the powder layer by assessing a mean level of greyness. By detecting possible height deviations in the powder layer, it is possible to assess whether the previous layer has a surface morphology within an acceptable range in terms of height. In other words, if the analysis of the second image reveals possible height deviations, it means that the surface morphology is not in an acceptable range in terms of height. If, however, the analysis of the second image reveals no significant height deviations, then the surface morphology in terms of height may be in an acceptable range, such as in the case illustrated in FIG. 5e. If significant height deviations are detected by the processor 34 (by using the software), then the processor forms/draws topographic contours of those areas (the example in FIG. 5e does however not show such deviations) and the contours are then superimposed on a corresponding cross-section 52 of the CAD model (see FIG. 5f). This is done in a similar fashion as described above, with reference to FIG. 5c.

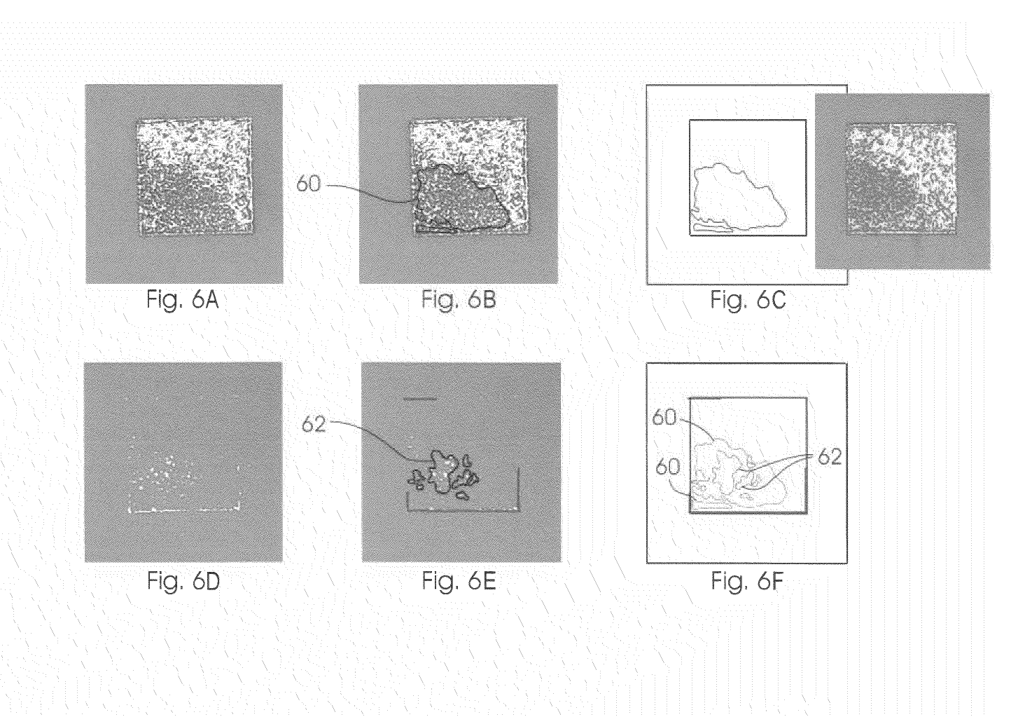

FIGS. 6a-f refer to a different scenario to the one illustrated in FIGS. 5a-f. In this scenario (i.e. shown in FIGS. 6a-f), the processor 34, by means of software, detects large dull grey areas (see FIG. 6b) in the manufactured layer (see the image captured in FIG. 6a). This indicates that the formation of this particular layer was not optimal. If detected, then the processor 34 creates/forms topographic contour(s) (e.g. in red) of the detected grey areas as indicated by reference numeral 60 in FIG. 6b and saves it on the database 36. The contour(s) is then superimposed on a cross-section 52 of the CAD model of the product being manufactured, wherein the cross-section corresponds to the manufactured layer of the product which image was captured by the camera 24.

After delivering the next layer of source powder 40, another image is captured by the camera 24 (see FIG. 6d) and analysed by the processor 34 in the same manner as described above. If the analysis shows that there are certain brighter areas, then the processor 34 creates/forms topographic contour(s) (e.g. in blue) of the detected bright areas as indicated by reference numeral 62 in FIG. 6e and saves it on the database 36.

In this instance, bright areas indicate a significant deviation from an average height in the previously manufactured layer and, during subsequent laser radiation there will be a high probability of the so-called “balling affect” in that particular region of the product being manufactured, if the layer-by-layer manufacturing continues without any adjustment. This effect can cause the creation of pores in a manufactured product, therefore possibly significantly impacting on its mechanical properties/integrity.

To avoid such a negative effect, it is necessary to change the control instructions/parameters for the particular contoured areas 60, 62. This is done by firstly superimposing the contoured areas 60, 62 onto the corresponding cross-section of the CAD module as shown in FIG. 6f. By increasing the energy input of the laser 16 exposure in the areas/regions indicated by the contours 60, 62 for the next layer, it will tend to result in a smoothing of the surface, hence reducing roughness/irregularities.

By having a topographic map for each layer, the processor 34, by means of the software, is able to adjust control instructions in respect of those contoured areas 60, 62 in order to increase the amount of energy/power applied to the next/second layer by the laser 16. This can be done by increasing the power of the laser 16 or decreasing a scanning speed in respect of those areas 60, 62.

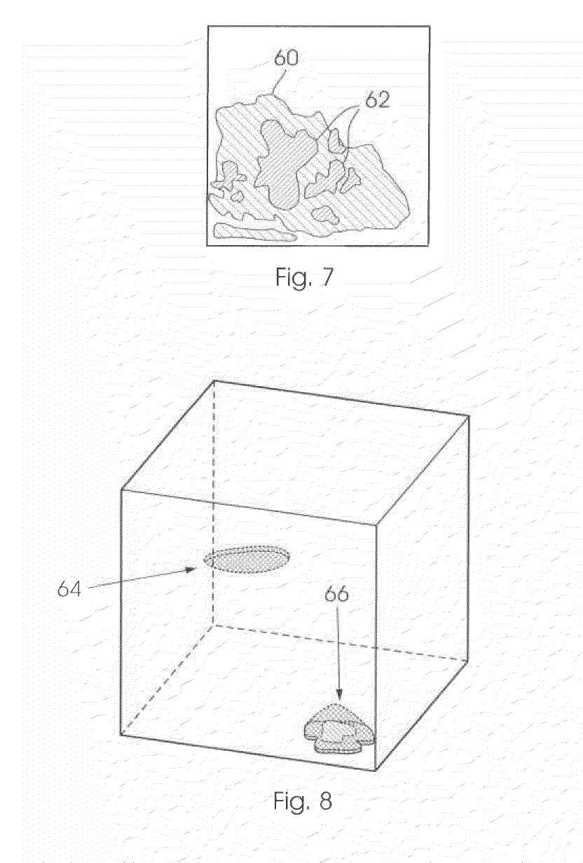

The contoured areas 60, 62 are shown in greater detail in FIG. 7. For those areas outside the contoured areas 60, 62 (i.e. the so-called white areas in the figure), the original control instructions will remain in place (see also FIG. 9, blocks 414 and 416). For the area indicated by reference numeral 60, the energy input (scanning power) from the laser 16 needs to be increased and the control instructions for that particular region 60 is therefore adjusted/adapted accordingly by the processor 34 (see also FIG. 9, blocks 414 and 418). The area indicated by reference numeral 62 is even more problematic than the region 60. For this reason, the energy input from the laser 16 for this particular region 62 should increase even more than for the region 60. The control instructions for this particular region 62 are therefore also adjusted/adapted accordingly by the processor 34 (again see FIG. 9, blocks 414 and 418).

This whole process is continued until the last layer of the product has been manufactured. By manufacturing the product in this manner, it will help reduce the effect of deviations from an average height which occur during the manufacturing of each layer. If surface irregularities therefore occur within the manufacture of a particular layer, then by adjusting the control instructions in the manner described above for the following layer (or two), the effect of the original irregularities will be reduced, and the control instructions for the layers which follow thereafter (e.g. the third layer onwards) will be the original control instructions. The system 10 can therefore be seen as having auto-correcting capabilities which is implemented as a product is being manufactured layer-by-layer.

By saving the details of the contours 60, 62 and superimposing them on each other layer-by-layer throughout the manufacturing process of a product, it is possible to obtain a so-called “certificate of quality” for the manufactured product, where possible problem areas can be clearly illustrated as shown in FIG. 8. The illustration may be shown graphically on a display screen and can be printed out, if required. It is therefore possible to illustrate graphically where certain surface irregularities are/may be present, as indicated generally by reference numerals 64 and 66.

Furthermore, by using software for analysing the behaviour of the manufactured product 300 at/under different loads, when having regard to the locations and sizes of the identified problem areas 64, 66 (i.e. where surface irregularities are present), it can be estimated under what loads the article can be used. The estimated life expectancy thereof may also be determined in a similar fashion (i.e. by taking the locations and sizes of the identified problem areas 64, 66 into account).

The present invention therefore not only allows a manufacturer to produce a certificate of quality for the manufactured product (which points to potential problem areas within the manufactured product), but also allows for the correction of potential problem areas in the product by dynamically adjusting the control instructions as the product is being manufactured layer-by-layer.

1. An additive manufacturing system for manufacturing a product layer-by-layer, wherein the system includes:
a production arrangement which is configured to manufacture a product layer-by-layer from source material, upon receiving instructions from a control arrangement, when in use;
a control arrangement, including a processor, which is operatively connected to the production arrangement and which is configured to control the operation of the production arrangement by providing control instruction for each layer of a product to be manufactured to the production arrangement, which can be used by the production arrangement in order to manufacture the product layer-by-layer;
an optical monitoring arrangement which is configured to capture an image of
a layer manufactured by the production arrangement, during the layer-by-layer manufacturing at a product, and/or
a layer of source material laid/placed over a previously manufactured layer of the product,
and wherein the optical monitoring arrangement is also configured to send the captured image to the control arrangement for processing,
wherein the control arrangement is configured to analyse the received captured image and, if required, to adjust control instructions for the manufacturing of the next layer and send the adjusted control instructions to the production arrangement.

2. The system of claim 1, wherein the optical monitoring arrangement includes a camera for capturing the image of a manufactured layer and/or a layer of source material.

3. The system of claim 1, wherein the control arrangement is configured, by way of software, to evaluate/identify surface irregularities of a layer manufactured by the system, by analysing a captured image of the manufactured layer received from the optical monitoring arrangement.

4. The system of claim 3, wherein the control arrangement is configured, by way of software:
to identify a region(s)/location(s) where surface irregularities are present in/on the manufactured layer by analysing the captured image thereof; and
to adjust control instructions for the next layer to be manufactured, if needed, based on at least the identified surface irregularities in the captured image.

5. The system of claim 4, wherein the control arrangement is more specifically configured to adjust the control instructions, if needed, for the next layer to be manufactured in respect of the particular region(s)/location(s) in/at which surface irregularities have been identified.

6. The system of claim 1, wherein the control arrangement is configured, by way of software, to:
superimpose the captured image, or an adaptation/derivative of the captured image, on/over a cross-section of a three-dimensional software model of the product, wherein the cross section corresponds with the layer which image was captured; and
to adjust control instructions for the next layer to be manufactured, if needed, based on an analysis of the superimposition of the captured image, or the adaptation/derivative of the captured image, on/over the said cross-section.

7. The system of claim 1, wherein the optical monitoring arrangement is configured to capture:
a first image of a first layer manufactured by the production arrangement, during the layer-by-layer manufacturing of a particular product, and
a second image of a layer of source material laid/placed over the first layer, wherein the layer of source material is to be used for manufacturing a next laser of the product.

8. The system of claim 7, wherein the control arrangement is configured, by way of software, to analyse both the first and second images and, if required, based on the analysis, to adjust control instructions for the second layer and send the adjusted control instructions to the production arrangement.

9. The system of claim 7, wherein the control arrangement is configured, by way of software, to superimpose both of the captured images, or adaptations/derivatives of the captured images, on/over a cross-section of a three-dimensional software model of the product, wherein the cross-section corresponds with the layer which image was captured.

10. The system of claim 9, wherein the control arrangement is configured, by way of software, to adjust control instructions for the next layer to be manufactured, if needed, based on an analysis of the superimposition of the two captured images, or the adaptations/derivatives of the captured images, on/over the said cross-section.

11. A method of manufacturing a product layer-by-layer by utilising an additive manufacturing system, the method inducing:
manufacturing a first layer of the product by using the additive manufacturing system;
capturing a first image of the first layer:
analysing, by using a processor, at least the captured first image and determining, by using a processor, whether or not control instructions for the system for the manufacturing of a next layer need to be adjusted, and
if needed, adjusting control instructions for the manufacturing of the next layer by using a processor.

12. The method of claim 11 wherein the step of analyzing the captured first image includes identifying surface irregularities in the manufactured first layer from at least the captured image.

13. The method of claim 11, wherein the step of analysing the captured first image includes superimposing at least the captured first image, or an adaptation/derivative of the captured first image, on/over a cross-section of a three-dimensional software model of the product, wherein the cross-section corresponds with the first layer.

14. The method of claim 11, which includes, after capturing the first image, delivering a layer of source material over the first manufactured layer, for the next layer of the product to be manufactured.

15. The method of claim 14, which includes, after delivering the layer of source material for the next layer, capturing a second image of the layer of source material.

16. The method of claim 15, wherein the step of analysing includes analysing, by using a processor, both the first and second images, and, if needed, adjusting control instructions for the manufacturing of the second layer, based on the analysis.

17. The method of claim 16, wherein the step of analysing the captured images includes:
superimposing the captured first and second images, or adaptations/derivatives thereof, on/over a cross-section of a three-dimensional software model of the product by using a processor, wherein the cross-section corresponds with the first layer; and
analysing, by using a processor, the superimposition of the captured images, or adaptations/derivatives thereof, and the three-dimensional software model of the product.

18. The method of claim 11, wherein
the step of analysing the captured image includes identifying region(s)/location(s) where surface irregularities are present in the first layer, by utilising the captured image, and
the step of determining whether or not control instructions need to be adjusted includes having regard to the identified surface irregularities in order to determine whether or not control instructions need to be adjusted.

19. A non-transitory computer-readable storage medium having computer-executable instructions adapted to cause an additive manufacturing system, which is configured to manufacture a product layer-by-layer, to perform the method as set out in claim 11.
